(19) United States
(12) Patent Application Publication
(10) Pub. No.: US 2022/0097862 A1
(43) Pub. Date: Mar. 31, 2022

(54) PROPULSION SYSTEM

(71) Applicant: HONDA MOTOR CO., LTD., Tokyo (JP)

(72) Inventor: Yukinobu Sugitani, Wako-shi (JP)

(21) Appl. No.: 17/477,576

(22) Filed: Sep. 17, 2021

(30) Foreign Application Priority Data
Sep. 25, 2020 (JP) 2020-160355

(51) Int. Cl. B64D 27/24; B64D 27/10; B64D 33/08

(52) U.S. Cl. CPC B64D 27/24; B64D 2027/026; B64D 33/08; B64D 27/10

(57) ABSTRACT

Provided is a propulsion system, including: a gas turbine mounted to an airplane; a generator connected to the gas turbine; a battery that stores power generated by the generator; a motor that is driven by power supplied from the generator and/or power supplied from the battery; a rotor that is driven by the motor; a first flow path that allows first fluid discharged from the gas turbine to flow; a second flow path that allows second fluid flowing near the battery to circulate; a heat exchanger that causes the first fluid and the second fluid to exchange heat; a controller that controls opening/closing of a flow path opening/closing valve provided in the first flow path; and a temperature detector that detects a temperature of the battery, in which, when the temperature is equal to or lower than a first temperature, the controller opens the flow path opening/closing valve.

### CROSS-REFERENCE TO RELATED APPLICATION

The application is based on Japanese Patent Application No. 2020-160355 filed on Sep. 25, 2020, the content of which incorporated herein by reference.

### BACKGROUND

### Field of the Invention

The present invention relates to a propulsion system for an airplane.

### Description of Related Art

Hitherto, there has been known a so-called hybrid propulsion system for an airplane. In the hybrid propulsion system disclosed in Japanese Patent Application Laid-open No. 2020-69975, a generator is connected to a gas turbine mounted to the body of an airplane, and power supplied from the generator and/or power supplied from a battery is used to drive a plurality of rotors (propellers or fans) via a motor. In general, when heat generated at the time of charging/discharging exceeds an upper limit temperature of a battery, the charging efficiency of the battery deteriorates. Thus, in this system, a closed-loop cooling circuit or the like is used to cool the battery appropriately.

Meanwhile, the charging efficiency deteriorates also when the temperature of the batter is too low. However, the system disclosed in Japanese Patent Application Laid-open No. 2020-69975 does not consider heating the battery. As a result, there is a problem in that, when the temperature of the batter is low, the battery is required to be charged under a state in which the charging efficiency is low, leading to a longer charging time.

### SUMMARY

The present invention has been made in view of the above-mentioned circumstances, and has an object to provide a propulsion system capable of improving a charging efficiency by controlling the temperature of a battery to reach a temperature appropriate for charging.

A propulsion system according to an embodiment of the present invention adopts the following configuration.

(1): A propulsion system according to an aspect of the present invention includes: a gas turbine mounted to an airplane; a generator connected to the gas turbine; a battery that stores power generated by the generator; a motor that is driven by power supplied from the generator and/or power supplied from the battery; a rotor that is driven by the motor; a first flow path that allows first fluid discharged from the gas turbine to flow; a second flow path that allows second fluid flowing near the battery to circulate; a heat exchanger that causes the first fluid flowing through the first flow path and the second fluid flowing through the second flow path to exchange heat; a controller that controls opening/closing of a flow path opening/closing valve provided in the first flow path; and a temperature detector that detects a temperature of the battery. When the temperature detected by the temperature detector is equal to or lower than a first temperature, the controller opens the flow path opening/closing valve to cause the first fluid to flow through the heat exchanger and heat the battery.
(2): In the aspect (1), when the temperature detected by the temperature detector is higher than the first temperature, the controller closes the flow path opening/closing valve.
(3): In the aspect (2), the propulsion system further includes a cooling device configured to cool the second fluid flowing through the second flow path. When the temperature detected by the temperature detector is higher than a second temperature being higher than the first temperature, the controller closes the flow path opening/closing valve and activates the cooling device.
(4): In the aspect (1), when the temperature detected by the temperature detector is higher than a third temperature being higher than the first temperature under a state in which the flow path opening/closing valve is closed, the controller closes the flow path opening/closing valve.
(5): In the aspect (4), the propulsion system further includes a cooling device configured to cool the second fluid flowing through the second flow path. When the temperature detected by the temperature detector is higher than a second temperature being higher than the third temperature, the controller closes the flow path opening/closing valve and activates the cooling device.
(6): In the aspect (1), the controller is configured to acquire information indicating an altitude of the airplane, and change the first temperature so that the first temperature becomes higher as the altitude becomes higher.
(7): In the aspect (6), the first fluid is engine lubricant in the gas turbine, compressed high temperature air compressed by a compressor of the gas turbine, or combustion gas discharged from the gas turbine.

According to the aspects (1) to (7), it is possible to control the temperature of the battery to reach the temperature appropriate for charging by causing the first fluid to flow through the heat exchanger and heat the battery when the temperature detected by the temperature detector is equal to or lower than the first temperature.

According to the aspect (2), it is possible to prevent the temperature of the battery from exceeding the temperature appropriate for charging and becoming higher excessively by closing the flow path opening/closing valve when the temperature detected by the temperature detector is higher than the first temperature.

According to the aspect (3) or the aspect (5), it is possible to decrease the temperature of the battery to reach the temperature appropriate for charging by activating the cooling device when the temperature detected by the temperature detector is higher than the second temperature being higher than the first temperature.

According to the aspect (4), it is possible to prevent hunting in which the flow path opening/closing valve switches frequently by closing the flow path opening/closing valve when the temperature detected by the temperature detector is higher than the third temperature being higher than the first temperature.

According to the aspect (6), it is possible to control the temperature of the battery to reach the temperature appropriate for charging more reliably even in an environment in which the temperature of the battery is more likely to decrease than usual by changing the first temperature depending on the altitude.

### BRIEF DESCRIPTION OF THE DRAWINGS

FIG. 1 is a block diagram illustrating an example of a configuration of a propulsion system 1 for an airplane.

FIG. 2 is a diagram illustrating partial structure of a gas turbine and a high temperature flow path.

FIG. 3 is a diagram for describing an operation of a control device in a first control example.

FIG. 4 is a diagram illustrating an example of temporal change in operation of the control device 140 configured to perform control in the first control example.

FIG. 5 is a flow chart illustrating an example of an operation of the control device 140 in a second control example.

FIG. 6 is a diagram for describing change in first temperature that depends on a flight altitude of the airplane.

### DESCRIPTION OF EMBODIMENTS

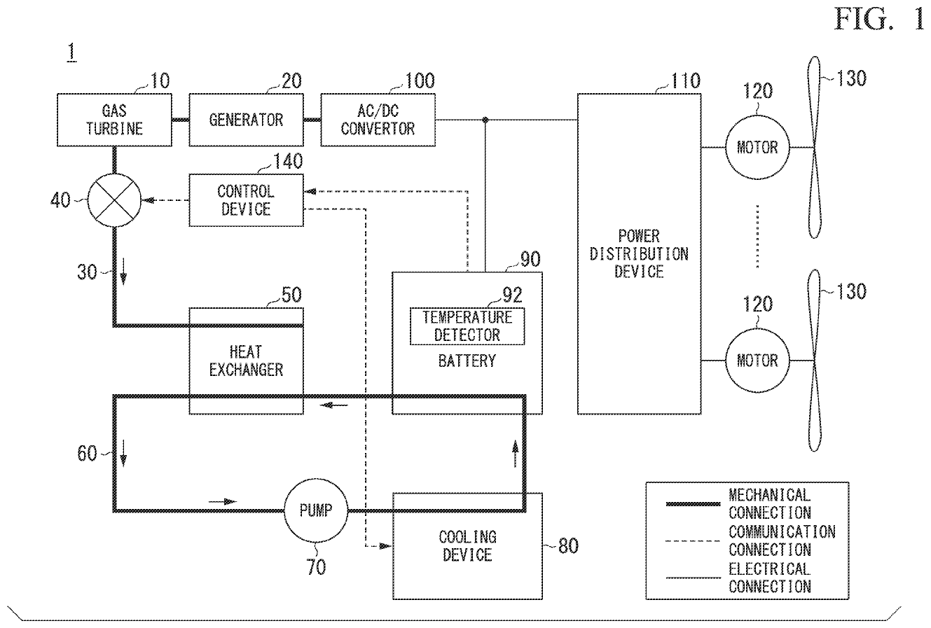

Now, description is given of an embodiment of the present invention with reference to the drawings. FIG. 1 is a block diagram illustrating an example of a configuration of a propulsion system 1 for an airplane. The propulsion system 1 includes, for example, a gas turbine 10, a generator 20, a high temperature flow path 30, a flow path opening/closing valve 40, a heat exchanger 50, a low temperature flow path 60, a pump 70, a cooling device 80, a battery 90, a power distribution device 110, one or more (a plurality of) motors 120 and rotors 130, and a control device 140.

The gas turbine 10 is a mechanism for compressing and burning introduced air, and rotating a turbine by using energy obtained through combustion. The gas turbine 10 may be a publicly known gas turbine, and is, for example, a turboshaft engine, a turbojet engine, or a turbofan engine. A specific configuration of the gas turbine 10 is described later.

The generator 20 is connected to the output shaft of the gas turbine 10. The generator 20 is a generator such as a synchronous generator-motor. The generator 20 generates power by using rotational energy of the output shaft of the gas turbine 10. The generated power is converted into DC power through an AC/DC convertor 100, and then transmitted to the battery 90 or the power distribution device 110.

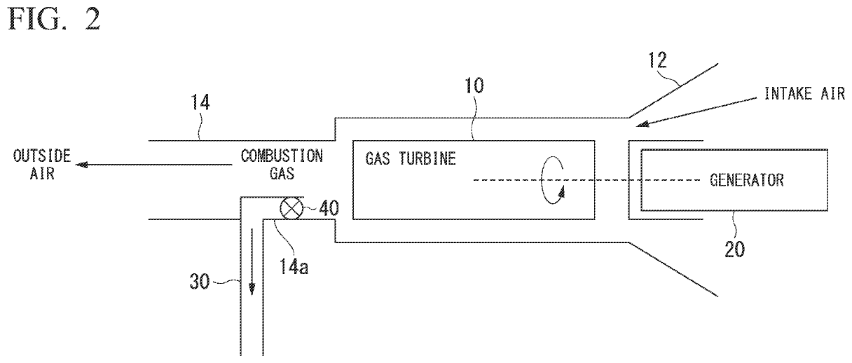

The high temperature flow path 30 (first flow path) is an air duct for acquiring a part of high temperature fluid (first fluid) such as combustion gas discharged by the gas turbine 10, and introducing the acquired part of high temperature fluid into the heat exchanger 50. In this embodiment, the high temperature fluid is combustion gas, but may be engine lubricant inside the gas turbine 10, compressed high temperature air compressed in the compressor of the gas turbine 10, or combustion gas discharged by the gas turbine 10, for example. A connection relationship between the high temperature flow path 30 and the gas turbine 10 is described later with reference to FIG. 2.

The flow path opening/closing valve 40 is installed in the middle of the high temperature flow path 30 or near the inlet of the high temperature flow path 30, and opening/closing of the flow path opening/closing valve 40 is controlled by the control device 140. When the flow path opening/closing valve 40 is opened, high temperature fluid is introduced into the heat exchanger 50, whereas when the flow path opening/closing valve 40 is closed, high temperature fluid is not introduced into the heat exchanger 50.

High temperature fluid flowing through the high temperature flow path 30 and low temperature fluid (second fluid) flowing through the low temperature flow path 60 are introduced into the heat exchanger 50, and the high temperature fluid and the low temperature fluid exchange heat. The low temperature fluid heated by heat exchange flows through the low temperature flow path 60 near the battery 90, and heats the battery 90 through exchange of heat with the battery 90. The heat exchanger 50 is, for example, any heat exchanger such as a finned tube heat exchanger.

The low temperature fluid is, for example, water, and the low temperature flow path 60 (second flow path) is a pipeline in that case. The low temperature flow path 60 flows inside the heat exchanger 50 and the cooling device 80, and is set near the battery 90 to enable heating or cooling of the battery 90.

The pump 70 adds pressure to low temperature fluid, and causes the low temperature fluid to circulate through the low temperature flow path 60 in a desired direction.

The cooling device 80 is a device for cooling low temperature fluid. The low temperature fluid cooled by the cooling device 80 flows into the battery 90, and cools the battery 90 through exchange of heat with the battery 90.

The battery 90 is a chargeable/dischargeable secondary battery. The battery 90 is, for example, a lithium ion battery or a nickel metal hydride battery, and is connected to a DC terminal of the AC/DC convertor 100 and an input terminal of the power distribution device 110. The battery 90 stores power generated by the generator 20.

A temperature detector 92 such as a temperature sensor is mounted to the battery 90. The temperature detector 92 is a publicly known temperature sensor, and transmits information indicating the detected temperature of the battery 90 to the control device 140.

The AC/DC convertor 100 converts AC power generated by the generator 20 into DC power. The converted DC power is used by the motor 120 or stored in the battery 90 through the power distribution device 110.

The power distribution device 110 distributes power supplied to the input terminal into a plurality of motors 120.

The motor 120 is, for example, a brushless DC motor. A drive circuit such as an inverter (not shown) is mounted to the motor 120, for example, and the drive circuit uses power supplied from the power distribution device 110 to drive the motor 120.

The output shaft of the motor 120 is connected to the rotor 130, and the motor 120 rotates the rotor 130 in accordance with power supplied from the power distribution device 110.

The control device 140 is implemented by, for example, a hardware processor such as a central processing unit (CPU) executing a program (software). The control device 140 may be implemented by hardware (circuit such as circuitry) such as a large scale integration (LSI), an application specific integrated circuit (ASIC), or a field-programmable gate array (FPGA), or a graphics processing unit (GPU), or may be implemented through cooperation between software and hardware. The program may be stored in a storage device (storage device including non-transitory storage medium) such as a hard disk drive (HDD) or a flash memory in advance, or stored in a detachable storage medium (non-transitory storage medium) such as a DVD or a CD-ROM, and may be installed into the storage device by the storage medium being mounted to a drive device.

The control device 140 receives information indicating the temperature of the battery 90 from the temperature detector 92, and controls opening/closing of the flow path opening/closing valve 40 and an operation of the cooling device 80 in accordance with the information. Specifically, when the temperature detected by the temperature detector 92 is equal to or lower than a first temperature T1, the control device 140 opens the flow path opening/closing valve 40 to cause high temperature fluid to flow into the heat exchanger 50 and heat the battery 90. At this time, the control device 140 stops an operation of the cooling device 80. On the other hand, when the detected temperature is higher than a predetermined second temperature T2 being higher than the first temperature T1, the control device 140 closes the flow path opening/closing valve 40 to activate the cooling device and cool the battery 90. When the detected temperature is between the first temperature T1 and the second temperature T2, the control device 140 closes the flow path opening/closing valve 40 and does not activate the cooling device. In this manner, the control device 140 can improve the charging efficiency by controlling the temperature of the battery 90 to reach the temperature appropriate for charging.

Next, description is given of specific structure of introduction of high temperature fluid from the gas turbine 10 into the high temperature flow path 30. FIG. 2 is a diagram illustrating partial structure of the gas turbine 10 and the high temperature flow path 30.

The gas turbine 10 compresses air inhaled from the inlet port 12 by the compressor, sprays fuel into the compressed air in a combustion chamber to burn the fuel, and uses energy obtained through combustion to rotate the turbine. As described above, the generator 20 is connected to the output shaft of the gas turbine 10, and the output shaft rotates to cause the generator 20 to generate power. Air is introduced into the gas turbine 10 without passing through the generator 20. High temperature fluid such as combustion gas generated through combustion is discharged into the outside (outside air) through an exhaust flow path 14.

In this embodiment, a sub flow path 14a is set on the side surface of the exhaust flow path 14. When the flow path opening/closing valve 40 is closed, combustion gas discharged from the gas turbine 10 is all discharged into the outside. On the other hand, when the flow path opening/closing valve 40 is opened, a part of combustion gas discharged from the gas turbine 10 is guided into the sub flow path 14a. The combustion gas guided into the sub flow path 14a is introduced into the high temperature flow path 30.

### First Control Example

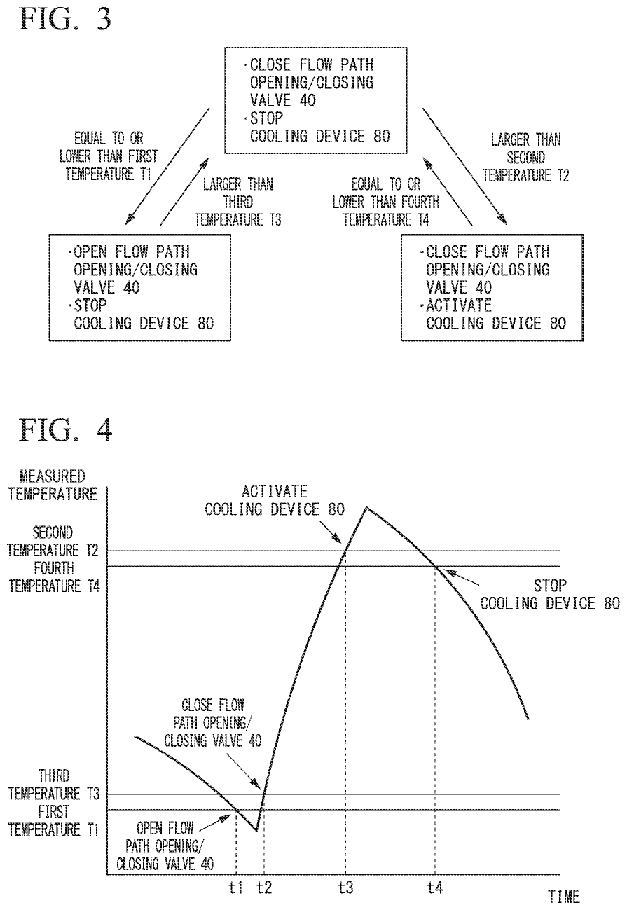

Next, description is given of a first control example of the control device 140 with reference to FIG. 3. FIG. 3 is a diagram for describing an operation of the control device 140 in the first control example. The control device 140 receives information indicating the temperature of the battery 90 from the temperature detector 92, and compares the temperature with the first temperature T1 and the second temperature T2 set in advance. In order for the battery 90 to operate efficiently within a range of, for example, from about 20 degrees to about 50 degrees, the first temperature T1 is set to, for example, about 20 degrees, and the second temperature T2 is set to, for example, about 50 degrees. However, the first temperature T1 and the second temperature T2 may be any temperature set in accordance with the characteristic of the battery 90.

When the detected temperature is equal to or lower than the first temperature T1, the control device 140 opens the flow path opening/closing valve 40, and stops the cooling device 80. As a result, a part of combustion gas discharged from the gas turbine 10 flows through the high temperature flow path 30, and reaches the heat exchanger 50. In the heat exchanger 50, combustion gas flowing through the high temperature flow path 30 and water flowing through the low temperature flow path 60 exchange heat, and water is heated. Heated water reaches the battery 90 via the pump 70 and the stopped cooling device 80, and heats the battery 90. As a result, the temperature of the battery 90 increases.

When the detected temperature is higher than a third temperature T3 being higher than the first temperature T1 as a result of increase in temperature of the battery 90, the control device 140 closes the flow path opening/closing valve 40. At this time, the control device 140 keeps the cooling device 80 stopped. Then, heating of water using combustion gas is finished, and as a result, heating of the battery 90 is also finished. The third temperature T3 is a temperature high enough to be capable of preventing hunting with respect to the first temperature T1.

When the detected temperature is higher than the second temperature T2, the control device 140 activates the cooling device 80 while keeping the flow path opening/closing valve 40 closed. Then, water flowing through the low temperature flow path 60 is cooled by the cooling device 80, and cooled water flowing to the battery 90 cools the battery 90. As a result, the temperature of the battery 90 decreases.

When the detected temperature is lower than a fourth temperature T4 being lower than the second temperature T2 as a result of decrease in temperature of the battery 90, the control device 140 stops the cooling device 80. At this time, the control device 140 keeps the flow path opening/closing valve 40 closed. Then, cooling of water using the cooling device 80 is finished, and as a result, cooling of the battery 90 is also finished. The fourth temperature T4 is a temperature low enough to be capable of preventing hunting with respect to the second temperature T2.

As described above, according to the first control example, when the temperature of the battery 90 is equal to or lower than the first temperature T1, the flow path opening/closing valve 40 is closed to heat the battery 90. In this manner, it is possible to improve the charging efficiency by controlling the temperature of the battery 90 to reach the temperature appropriate for charging. Furthermore, according to the first control example, when the temperature of the battery 90 is higher than the second temperature T2, the cooling device 80 is activated to cool the battery 90. In this manner, it is possible to further improve the charging efficiency by controlling the temperature of the battery 90 to reach the temperature appropriate for charging.

Furthermore, according to the first control example, the third temperature T3 being higher than the first temperature T1 is used to determine whether to close the flow path opening/closing valve 40, and the fourth temperature T4 being lower than the second temperature T2 is used to determine whether to stop the cooling device 80. In a case where only the first temperature T1 and the second temperature T2 are used for these determinations, when the detected temperature is close to the first temperature T1 or the second temperature T2, the detected temperature crosses the temperature frequently, and the operation of the flow path opening/closing valve 40 or the cooling device 80 may switch frequently (hunting). According to the first control example, it is possible to prevent hunting by using third temperature T3 and the fourth temperature T4 in addition to the first temperature T1 and the second temperature T2.

FIG. 4 is a diagram illustrating an example of temporal change in operation of the control device 140 configured to perform control in the first control example. First, in an initial state, the flow path opening/closing valve 40 is closed, and the cooling device 80 is stopped. At a time point t1, the temperature of the battery 90 detected by the temperature detector 92 of the battery 90 is equal to or lower than the first temperature T1. Then, the control device 140 opens the flow path opening/closing valve 40. In this manner, a part of combustion gas discharged from the gas turbine 10 flows through the high temperature flow path 30, and reaches the heat exchanger 50. In the heat exchanger 50, combustion gas flowing through the high temperature flow path 30 and water flowing through the low temperature flow path 60 exchange heat, and water is heated. Heated water reaches the battery 90 via the pump 70 and the stopped cooling device 80, and heats the battery 90. As a result, the temperature of the battery 90 increases.

As a result of increase in temperature of the battery 90, at a time t2, the detected temperature is higher than the third temperature T3 under a state in which the flow path opening/closing valve 40 is opened. Then, the control device 140 closes the flow path opening/closing valve 40. At this time, the control device 140 keeps the cooling device 80 stopped. Then, heating of water using combustion gas is finished, and as a result, heating of the battery 90 is also finished.

After that, at a time point t3, the detected temperature is higher than the second temperature T2. Then, the control device 140 activates the cooling device 80 while keeping the flow path opening/closing valve 40 closed. Then, water flowing through the low temperature flow path 60 is cooled by the cooling device 80, and cooled water flowing to the battery 90 cools the battery 90. As a result, the temperature of the battery 90 decreases.

As a result of decrease in temperature of the battery 90, at a time point t4, the detected temperature is equal to or lower than the fourth temperature T4. Then, the control device 140 stops the cooling device 80. At this time, the control device 140 keeps the flow path opening/closing valve 40 closed. Then, cooling of water using the cooling device 80 is finished, and as a result, cooling of the battery 90 is also finished.

### Second Control Example

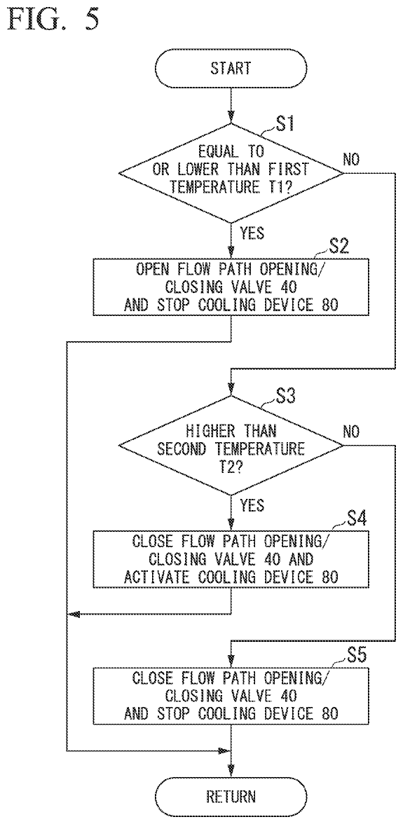

Next, description is given of a second control example of the control device 140 with reference to FIG. 5. In the second control example, only the first temperature T1 and the second temperature T2 are used to determine opening/closing of the flow path opening/closing valve 40 and activation of the cooling device 80, to thereby simplify the first control example. FIG. 5 is a flow chart illustrating an example of an operation of the control device 140 in the second control example. The processing of this flow chart is executed repeatedly at a predetermined period, for example.

First, the control device 140 receives information indicating the temperature of the battery 90 from the temperature detector 92, and determines whether or not the temperature is equal to or lower than the first temperature T1 (Step S1). When the control device 140 determines that the temperature of the battery 90 is equal to or lower than the first temperature T1, the control device 140 stops the cooling device 80 while at the same time opening the flow path opening/closing valve 40 (Step S2). Then, the battery 90 is heated.

When it is determined that the temperature of the battery 90 is higher than the first temperature T1, the control device 140 determines whether or not the temperature of the battery 90 is higher than the second temperature T2 (Step S3). When it is determined that the temperature of the battery 90 is higher than the second temperature T2, the control device 140 activates the cooling device 80 while at the same time closing the flow path opening/closing valve 40 (Step S4). Then, the battery 90 is cooled.

When it is determined that the temperature of the battery 90 is higher than the first temperature T1 and equal to or lower than the second temperature T2, the control device 140 stops the cooling device 80 while at the same time closing the flow path opening/closing valve 40 (Step S5). Then, the battery 90 is not heated or cooled.

As described above, according to the second control example, only the first temperature T1 and the second temperature T2 are used to determine opening/closing of the flow path opening/closing valve 40 and activation of the cooling device 80. In this manner, it is possible to improve the charging efficiency by controlling the temperature of the battery 90 to reach the temperature appropriate for charging with simpler processing.

In the above-mentioned embodiment, the control device 140 compares the temperature of the battery 90 with a threshold value, and determines opening/closing of the flow path opening/closing valve 40 and activation of the cooling device 80. Instead, the control device 140 may execute only opening/closing of the flow path opening/closing valve 40 based on the threshold value, and omit activation of the cooling device 80. Also in this case, when the temperature of the battery 90 has decreased, the battery 90 is heated by opening the flow path opening/closing valve 40, to thereby be able to control the temperature of the battery 90 to reach the temperature appropriate for charging.

Furthermore, in the above-mentioned embodiment, the threshold values, namely, the first temperature T1 to the fourth temperature T4 are set as fixed values in advance. Instead, various kinds of threshold values may be changed flexibly depending on the condition of an airplane or weather conditions. For example, in general, it is known that as the flight altitude of the airplane become higher, the temperature also decreases. The temperature of the battery 90 mounted to the airplane may decrease as the temperature decreases. Therefore, the control device 140 may acquire information indicating the altitude of the airplane by using, for example, an altimeter, and change the first temperature T1 so that the first temperature T1 becomes higher as the altitude becomes higher.

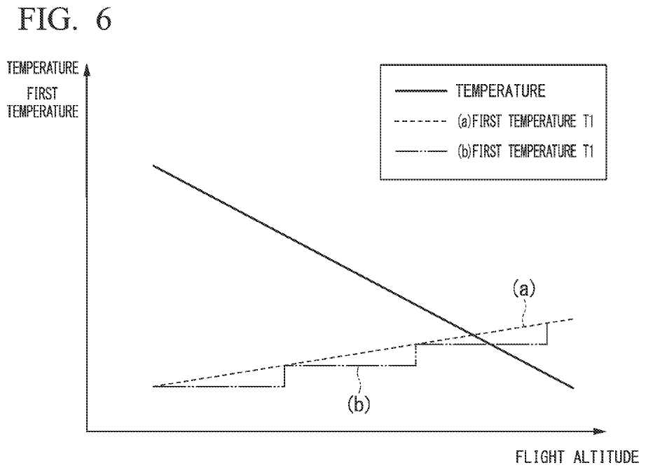

FIG. 6 is a diagram for describing change in first temperature T1 that depends on the flight altitude of the airplane. As illustrated in FIG. 6, as the flight altitude of the airplane becomes higher, the temperature indicated by the solid line decreases. Thus, the first temperature T1 may be set to increase linearly as indicated by a transition line (a) as the flight altitude of the airplane becomes higher, or may be set to increase stepwise as indicated by a transition line (b) as the flight altitude of the airplane becomes higher. Alternatively, the first temperature T1 may be set to increase to form a curve as the flight altitude of the airplane becomes higher. Alternatively, a pilot of the airplane may change the first temperature T1 based on his or her own decision depending on the path. As a result, the pilot can perform, for example, an operation of increasing the first temperature when the airplane flies at a high flight altitude. In this case, the control device 140 receives the settings of the first temperature T1 given by a user such as a pilot.

This concludes the description of the embodiment for carrying out the present invention. The present invention is not limited to the embodiment in any manner, and various kinds of modifications and replacements can be made within a range that does not depart from the gist of the present invention.

What is claimed is:

1. A propulsion system, comprising:
a gas turbine mounted to an airplane;
a generator connected to the gas turbine;
a battery that stores power generated by the generator;
a motor that is driven by power supplied from the generator and/or power supplied from the battery;
a rotor that is driven by the motor;
a first flow path that allows first fluid discharged from the gas turbine to flow;
a second flow path that allows second fluid flowing near the battery to circulate;
a heat exchanger that causes the first fluid flowing through the first flow path and the second fluid flowing through the second flow path to exchange heat;
a controller that controls opening/closing of a flow path opening/closing valve provided in the first flow path; and
a temperature detector that detects a temperature of the battery,
wherein, when the temperature detected by the temperature detector is equal to or lower than a first temperature, the controller opens the flow path opening/closing valve to cause the first fluid to flow through the heat exchanger and heat the battery.

2. The propulsion system according to claim 1, wherein, when the temperature detected by the temperature detector is higher than the first temperature, the controller closes the flow path opening/closing valve.

3. The propulsion system according to claim 2, further comprising a cooling device configured to cool the second fluid flowing through the second flow path,
wherein, when the temperature detected by the temperature detector is higher than a second temperature being higher than the first temperature, the controller closes the flow path opening/closing valve and activates the cooling device.

4. The propulsion system according to claim 1, wherein, when the temperature detected by the temperature detector is higher than a third temperature being higher than the first temperature under a state in which the flow path opening/closing valve is closed, the controller closes the flow path opening/closing valve.

5. The propulsion system according to claim 4, further comprising a cooling device configured to cool the second fluid flowing through the second flow path,
wherein, when the temperature detected by the temperature detector is higher than a second temperature being higher than the third temperature, the controller closes the flow path opening/closing valve and activates the cooling device.

6. The propulsion system according to claim 1, wherein the controller is configured to acquire information indicating an altitude of the airplane, and change the first temperature so that the first temperature becomes higher as the altitude becomes higher.

7. The propulsion system according to claim 1, wherein the first fluid is engine lubricant in the gas turbine, compressed high temperature air compressed by a compressor of the gas turbine, or combustion gas discharged from the gas turbine.
